(19) United States
(12) Patent Application Publication
(10) Pub. No.: US 2023/0150239 A1
(43) Pub. Date: May 18, 2023

(54) THERMOFORMABLE SHAPE-MEMORY DEVICE AND USES THEREOF

(71) Applicant: MILLET INNOVATION, Loriol-sur-Drôme (FR)

(72) Inventors: Hugo LAURENT, Montelimar (FR); Clément ANKAOUA, Grenoble (FR); Maria Luisa TREPIER-LE BELLER, Étoile-sur-Rhône (FR)

(21) Appl. No.: 17/998,118

(22) PCT Filed: Apr. 26, 2021
(86) PCT No.: PCT/FR2021/050719

§ 371 Date: Nov. 7, 2022

(30) Foreign Application Priority Data
May 6, 2020 (FR) 2004508

(51) Int. Cl. B32B 7/027; B33Y 80/00; B32B 1/08; B32B 7/12; B32B 7/08; B32B 3/30; B32B 37/12; B32B 37/14; B32B 37/18; B29C 65/48; B29C 65/56; B29C 65/00; B29C 51/14; B32B 27/08; B32B 5/18; B32B 27/06; B32B 27/36; B32B 27/30; B32B 27/32; B32B 27/40; B32B 27/28; B29D 35/14; A43B 13/04; A43B 13/12

(52) U.S. Cl. CPC B32B 7/027; B33Y 80/00; B32B 1/08; B32B 7/12; B32B 7/08; B32B 3/30; B32B 37/12; B32B 37/144; B32B 37/182; B29C 65/48; B29C 65/565; B29C 66/45; B29C 51/14; B29C 66/7311; B29C 66/73921; B32B 27/08; B32B 5/18; B32B 27/065; B32B 27/36; B32B 27/306; B32B 27/32; B32B 27/40; B32B 27/283; B29D 35/14; A43B 13/04; A43B 13/12; B29K 2995/0079; B32B 2307/546; B29K 2995/007; B32B 2307/536; B29L 2031/507

(57) ABSTRACT

The invention relates to a device comprising: a first layer (11) of a thermoformable material that is inelastically deformable in a thermoforming temperature range, a second layer (1) of a viscoelastic material that is elastically deformable in a temperature range including a use temperature range of the device and the thermoforming temperature range, and wherein: the use temperature range is lower than the thermoforming temperature range, the first layer is bonded to the second layer, the thermoformable material is elastically deformable and more rigid than the viscoelastic material in the use temperature range, the thermoformable material is less rigid than the viscoelastic material in the thermoforming temperature range.

### CROSS-REFERENCE TO RELATED APPLICATIONS

This application is a 371 National Stage of International Application No. PCT/FR2021/050719, filed Apr. 26, 2021, which claims priority to French Patent Application No. 2004508, filed May 6, 2020, the disclosures of which are herein incorporated by reference in their entirety.

### BACKGROUND

The present invention relates to a device having an initial shape that can be durably modified if subjected to a certain temperature range and capable of recovering its initial shape if exposed to this temperature without constraints. The present invention applies in particular to devices applied to a human and/or animal body, such as insoles, slippers, shoes, splints, corsets, neck braces, handles and grips for sports use or present in hand tools, saddles, seats, backrests, backpacks, protective equipment (breastplates, helmets, shoulder pads, elbow pads, knee pads, back protectors, protective vests . . . ).

Each individual has a unique morphology. Therefore, an interface between an individual's body and an object can only be perfectly optimized for certain applications if the interface fits the shape of the body it is in contact with.

Flexible and/or stretchable fabrics provide an optimal adaptation to the surface of a body, with the use of suitable patterns. Nevertheless, in some applications of health, clothing, protection, or comfort, it is necessary, for mechanical reasons, to put a more or less rigid object in contact with the surface of the body. The objects concerned by these applications cannot therefore be made solely of fabric or equivalents. For example, a device for supporting a joint must offer sufficient mechanical resistance to carry out its supporting function, while having at least two contact areas on the body on either side of the joint. As another example, devices used to protect an area of the body must offer hardness characteristics and sufficient thickness, while conforming to the surface of the body.

However, devices for these applications are still mainly mass-produced and are therefore only available in a limited number of sizes corresponding to different shapes and dimensions, very rarely exceeding ten sizes for a single device. The category of mass-produced devices has the advantage of being relatively simple and inexpensive to manufacture, which explains why they are common. Although these devices, for the most part, try to reproduce the general shapes of the body surfaces with which they will be in contact, they never perfectly fit the body of their user.

Another category of devices for these applications are those that are custom-made, that is, manufactured according to and in the presence of the end-user's body surface, which allows for a much more precise match between the shape of the device and the user's morphology. Nevertheless, these custom-made products are generally more complex and costly to manufacture, preventing the savings resulting from mass production. In addition, the process of taking measurements of the user's body requires a time investment by the user before manufacturing can begin. Even if new digital technologies, such as 3D printing and 3D imaging, tend to reduce the impact of these concerns by automating the manufacturing of a unique digital model based on 3D anatomical data collected in digital files that may be created by the user himself, it remains that a custom-made device will only fit the body for which it was designed and will therefore be unsuitable for another user. Devices in this category are therefore only usable as long as the user needs them, which does not contribute to the reduction of waste and consumption of the planet's resources.

Another minority category of devices for these same applications is based on the use of solid formable materials, i.e. materials that can change shape when heated (thermoformable) or that can take on a solid form from a liquid or powder form. Thermoformable solid materials are usually provided in sheet form made of a single material or complexed with other materials sensitive to the same temperature ranges. By applying a certain temperature, the sheet is deformed by applying it to the intended area of the body. This thermoforming operation is usually performed by a professional, or by the user himself in some applications. Liquid or powder materials usually require the addition of at least one other component to trigger a chemical reaction that causes the material to solidify. During the chemical reaction, the material can be shaped to fit the target area of the body. These two techniques provide a unique device perfectly adapted to the shape of an area of the user's body, from a mass-produced material. Nevertheless, the realization of this type of device, although relatively fast, can be tricky and the intervention of a professional is often necessary to minimize the risk of error. Moreover, the device thus produced is generally not reversible, i.e. it is impossible to return it to its initial shape and thus to correct a molding error or to reuse it for another user. These devices therefore have the same defect as those made to measure by being user-specific, in addition to being difficult to implement, given the shaping step without margin of error.

Existing devices, with an interface in contact with an area of a user's body, are therefore either imperfectly adapted to this area, or complex to implement in addition to being user-specific.

Recently, thermoformable and shape-memory composite materials have been developed. These polymer-based materials may be easily shaped within a certain temperature range and have the ability to return to their original shape even within this temperature range in the absence of mechanical stress. To this end, these materials incorporate two types of fibers, namely fibers with a glass transition temperature within the desired thermoforming temperature range, and fibers with a glass transition temperature significantly higher than the desired thermoforming temperature range. Thus, a thermoformable and shape-memory material would allow shaping an object to the morphology of the user's body, while being able to return to its original shape. Some manufacturers propose materials of this type for the mass production of objects by plastic injection. However, commercially available materials of this type cover a limited spectrum of mechanical characteristics and are significantly more expensive than most materials used in plastic injection molding. Indeed, these materials are either insufficiently rigid for supporting a joint of the human body, or they are too expensive, or their thermoforming temperature is too high to allow shaping by applying the material to the body without risk of burning the user. The minimum flexural modulus to provide sufficient support while using mechanical strategies to stiffen an object by its shape (in particular by exploiting the quadratic moment) can be evaluated between 1 and 2 GPa depending on the size and the forces that apply to the joint or the part of the body to be supported.

It is also known to apply viscoelastic materials to an area of a user's body to absorb shock and/or distribute pressure. However, viscoelastic materials cannot be shaped generally at temperatures below 100° C. and are insufficiently rigid to support a joint or body part.

It may therefore be desirable to provide a device having an interface that can be adapted in a reversible manner to the shape of an area of a human or animal body, and that can be manufactured in series. In the context of applications of interfacing with an area of the human or animal body, it may also be desirable for the device to have shock absorbing and pressure distributing properties.

### SUMMARY

Embodiments relate to a method of manufacturing a thermoformable shape-memory device, the method comprising the steps of: forming a first layer of a thermoformable material that is inelastically deformable in a range of thermoforming temperatures; forming a second layer of a viscoelastic material that is elastically deformable in a temperature range including the thermoforming temperature range and a use temperature range lower than the thermoforming temperature range, wherein the thermoformable material is elastically deformable and stiffer than the viscoelastic material in the use temperature range; and joining the first layer to the second layer over a contact surface between the first layer and the second layer, by chemical bonding or mechanical bonds distributed over the contact surface, the device having a use shape defined by the first layer in the use temperature range, and having an original shape defined by the second layer providing a shape-memory function of the device in the thermoforming temperature range.

According to an embodiment, the first layer and the second layer are manufactured separately by molding or 3D printing and then assembled together, or the first layer is manufactured by molding or 3D printing and then placed in a mold for manufacturing the second layer, the second layer being formed by molding using the mold including the first layer, or the first layer is manufactured by molding or 3D printing, and forms a mold for the manufacture by molding of the second layer.

According to an embodiment, the method comprises the steps of: heating the device to a temperature within the thermoforming temperature range so that the device returns to the original shape defined by the second layer by transferring the original shape of the second layer to the first layer through the contact surface; and bringing the device to a temperature within the use temperature range in which the device is elastically deformable.

According to an embodiment, the method comprises the steps of: heating the device to a first temperature within the thermoforming temperature range, and applying a deformation to the device at the first temperature to conform the device to a shape distinct from the original shape; and bringing the device to a second temperature within the use temperature range while maintaining the deformation, the device at the second temperature being elastically deformable with respect to the shape distinct from the original shape.

Embodiments may also relate to a device comprising: a first layer of a thermoformable material that is inelastically deformable in a thermoforming temperature range; a second layer of a viscoelastic material that is elastically deformable in a temperature range including a use temperature range of the device and the thermoforming temperature range; and wherein: the use temperature range is lower than the thermoforming temperature range; the first layer is bonded to the second layer by a chemical bond or mechanical bonds distributed over a contact surface between the first layer and the second layer; the thermoformable material is elastically deformable and more rigid than the viscoelastic material in the use temperature range; the thermoformable material is less rigid than the viscoelastic material in the thermoforming temperature range; the first layer defines a form of use of the device in the use temperature range; and the second layer defines an original shape of the device and achieves a shape-memory function of the device in the thermoforming temperature range.

According to an embodiment, the first layer is bonded to the second layer by one or a combination of the following: a chemical bond made by a fusion of the materials forming the first and second layers, on either side of the contact surface between the first and second layers; a layer of glue or a double-sided adhesive film, capable of chemically bonding to the first and second layers; a mechanical connection based on a joining profile distributed over the contact surface; and a seam.

According to an embodiment, the first layer is embedded in the second layer, and/or the first layer comprises studs penetrating matching shaped holes in the second layer, and/or the second layer comprises studs penetrating matching shaped holes in the first layer.

According to an embodiment, the first layer is PCL, PETG, EVA, PE, PU or PLA, or a thermoformable resin with a glass transition temperature below 100° C., and/or has a stiffness between 1 and 2 GPa.

According to an embodiment, the second layer has at least one of the following features: is SEBS, or silicone, or silicone gel, or PU, EVA or PE foam; has a Shore A hardness between 1 and 30.

According to an embodiment, the second layer has the shape of an insole configured to cover the heel and the sole of a foot, and the first layer extends from the heel to the base of the metatarsal heads.

According to an embodiment, the second layer extends to the tip of the toes.

According to an embodiment, the first and second layers form a handle or a grip, intended to be held by a hand.

According to an embodiment, the second layer has a cylindrical shape, and the first layer has a tubular shape covering the second layer, or the second layer has a tubular shape, and the first layer comprises a tubular-shaped inner portion covering an inner surface of the second layer, and a tubular-shaped outer portion covering an outer surface of the second layer, or the second layer has a tubular shape, and the first layer comprises a tubular-shaped inner portion covering an inner surface of the second layer, the second layer being intended to be in contact with the hand.

### BRIEF DESCRIPTION OF THE DRAWINGS

Non-limiting examples of embodiments of the invention will be described in the following, in relation with the appended drawings among which:

FIGS. 1A, 1B are schematic top and cross-sectional views, respectively, along a sectional plane AA shown in FIG. 1A, of a composite material pad, according to an embodiment,

FIGS. 2A, 2B are schematic top and cross-sectional views, respectively, along a sectional plane BB shown in FIG. 2A, of a composite material pad, according to another embodiment,

FIGS. 3A, 3B are schematic top and cross-sectional views, respectively, along a sectional plane CC shown in FIG. 3A, of a composite material pad, according to another embodiment,

FIG. 4 is a cross-sectional view of a composite pad, according to another embodiment,

FIG. 5 is a perspective view of a portion of a handle made of a composite material according to an embodiment,

FIG. 6 is a perspective view of a portion of a handle made of a composite material according to another embodiment,

FIG. 7 is a perspective view of a composite material insole according to an embodiment.

### DETAILED DESCRIPTION

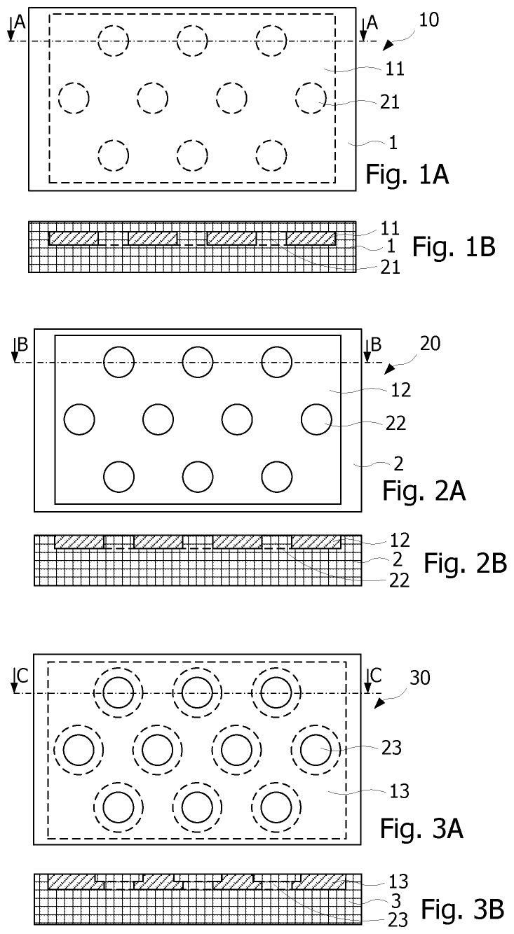

FIGS. 1A, 1B show a pad 10 made of a composite material, according to an embodiment. The pad 10 comprises a layer 1 of a viscoelastic material in which a layer 11 of a thermoformable material is embedded. The layer 1 is elastically deformable in a temperature range including a use temperature range of the pad 1, and a thermoforming temperature range of the layer 11, exceeding a glass transition temperature of the layer 11, in which the layer 11 is inelastically deformable, the use temperature range being lower than the thermoforming temperature range. Furthermore, in the use temperature range, the material of the thermoformable layer 11 is stiffer than the viscoelastic material of the layer 1, and in the thermoforming temperature range, the material of the thermoformable layer 11 is less rigid than the viscoelastic material of the layer 1.

Thus, in the use temperature range, the shape of the pad 10 is given by the shape of the thermoformable layer 11 which is stiffer than the viscoelastic layer 1. Due to the presence of the thermoformable layer 11, the pad 10 can be inelastically deformed after being heated to a temperature within the thermoforming temperature range, whereby the layer 1 crushes and/or elastically deforms. If this deformation is maintained while the pad 10 cools to a temperature in the use temperature range, the layer 11 maintains its shape and becomes more rigid, constraining the layer 1. The layer 11 then defines the shape of the pad 10. If the pad 10 is heated to a temperature in the thermoforming range without stressing its surface, the stiffer, elastically deformed layer 1 urges the layer 11 back to its original shape, which shape is maintained when the pad returns to a temperature in the use temperature range. As a result, the composite material made of layers 1 and 11 has both thermoformable and shape-memory properties.

It can be observed that most thermoformable materials, in contrast, do not have shape-memory properties, whereby, in the absence of an external force, a layer of thermoformable material does not naturally return to an initial shape at a thermoforming temperature.

In the example of FIGS. 1A, 1B, layer 11 has through holes 22 distributed across its surface, filled with the material of layer 1 to provide mechanical cohesion between layers 1 and 11 over the entire contact area between layers 1, 11.

According to an embodiment, the thermoforming temperature range is such that, within this range, the layer 11 can be deformed by hand without risk of burning. The thermoforming temperature range may thus be between 50 and 100° C. For example, the glass transition temperature of layer 11 is between 50 and 80° C., and the glass transition temperature of layer 1 (upper limit of the elastic deformation temperature range of layer 1) is above the thermoforming temperature range, for example above 110° C.

FIGS. 2A, 2B depict a pad 20 made of a thermoformable shape-memory composite material according to another embodiment. The pad 20 includes a layer 2 of the same viscoelastic material as layer 1, and a layer 12 of the same thermoformable material as layer 11. The pad 20 differs from the pad 10 in that the layer 12 is arranged on the surface of the layer 2.

The layers 2 and 12 are chemically bonded together. The chemical bonding between the two materials is achieved, for example, by blending the materials of the layers 2, 12 over a small thickness on either side of the interface between the two layers. This chemical bond may be achieved by bringing the two layers 2, 12 into contact before they are fully cured, with part of each of the two layers still in liquid form.

It should be noted that in the embodiment of FIGS. 1A, 1B, the two layers 1, 11 may also be chemically bonded, for example by blending the materials of the layers 1, 11 over a small thickness on either side of the interface between these two layers. In this case, the holes 21 may be omitted.

According to another embodiment, the layers 2, 12 are manufactured separately and joined to each other by a seam, and/or with the aid of a layer of another material capable of bonding to both layers 2, 12. This other material may include, for example, glue and/or double-sided adhesive film or fabric.

In the example of FIGS. 2A, 2B, the layer 12 also has holes 22, that may be blind, are open facing the layer 2 and are filled by the material forming the layer 2. The holes 22 increase the contact surface between the two layers 2, 12 and thus increase their cohesion.

FIGS. 3A, 3B depict a pad 30 made of a thermoformable shape-memory composite material according to another embodiment. The pad 30 comprises a layer 3 of the same viscoelastic material as layer 1, and a layer 13 of the same thermoformable material as layer 11. The pad 30 differs from the pad 20 in that the layer 13 is mechanically bonded to the layer 3. For this purpose, the layer 13 has holes 23 that may be blind, are open facing the layer 3 with a narrower cross-section than another part of the hole, the holes 23 being filled by the material forming the layer 3.

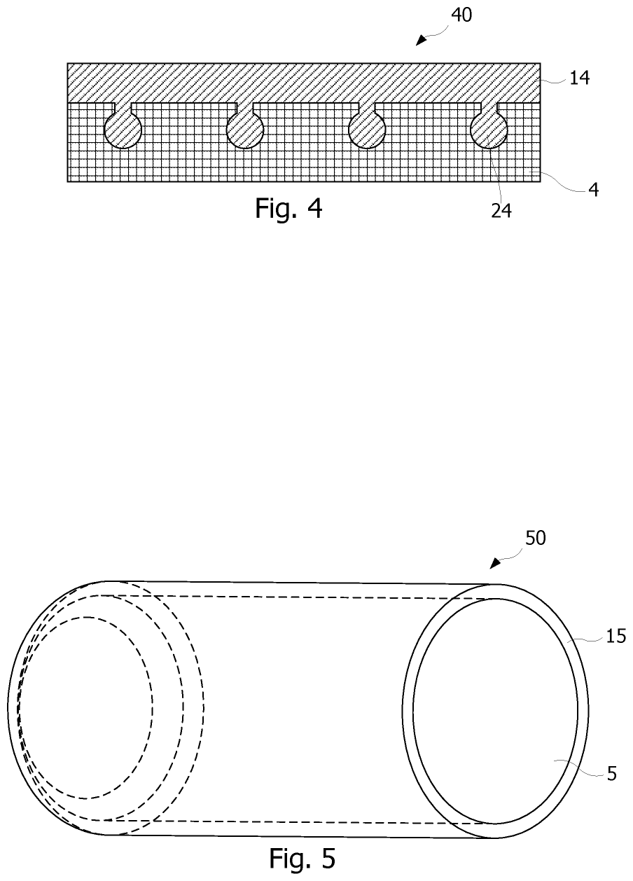

FIG. 4 shows a pad 40 made of a thermoformable shape-memory composite material, according to another embodiment. The pad 40 includes a layer 4 of the same viscoelastic material as layer 1, and a layer 14 of the same thermoformable material as layer 11. The pad 40 differs from the pad 30 in that the layer 14 is mechanically bonded to the layer 4 by studs 24 formed in the layer 14 and penetrating the layer 4 from the contact surface between layers 14 and 4. The layer 4 includes holes formed opposite the studs 24, that may be blind and are complementary in shape to the studs 24. Each of the studs may have a base that is narrower than another cross-section of the studs, providing a strong cohesion between layers 4, 14. Thus, the two layers 4, 14 may be fabricated separately, and then joined together by applying a relatively strong pressure to press the studs 24 of layer 14 into the facing holes formed in layer 4. Alternatively, layer 4 may be molded onto layer 14.

In the examples shown in FIGS. 1A, 2A, 3A, 4, the volumes of connectors 21, 22, 23, 24 have a circular cross-section. This cross-section may have other shapes, including that of grooves, that can be adapted to the desired cohesive force between the two layers, this cohesive force being related to the stresses, in particular torsional stresses, that the pad may withstand.

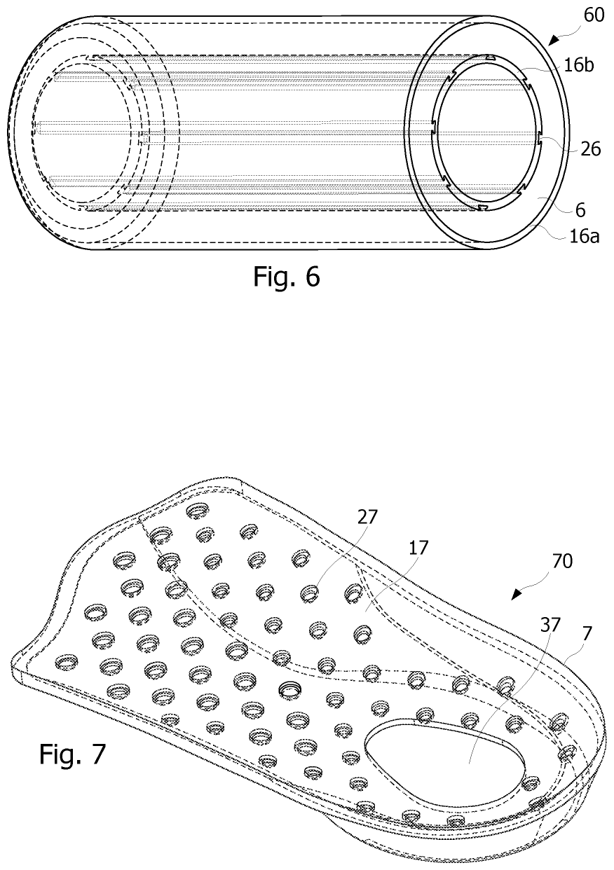

FIGS. 5 and 6 depict a portion of a cylindrical handle. In FIG. 5, the handle portion 50 includes a cylindrical viscoelastic layer 5 covered by a tubular thermoformable layer 15 enclosing the layer 5. The layer 5 may be formed from the same material as the layer 1 and the layer 15 may be formed from the same material as the layer 11. With layer 5 housed in layer 15, these two layers are mechanically bonded together. If it is desired that the contact area between the two layers 5, 15 not be altered as a result of a thermoforming operation of the thermoformable layer, the two layers may be chemically bonded together over the entire contact area in either of the ways described above, with or without the use of another material such as a double-sided adhesive film.

Thus, when the sleeve portion 50 is heated to a temperature within the thermoforming temperature range, the layer 15 can be deformed by hand, transmitting its deformations to the layer 5. If the sleeve portion 50 is cooled while maintaining its deformation, the deformation is maintained until the sleeve portion is heated again to a thermoforming temperature and left without mechanical stress to allow the elastically deformed layer 5 to return to its original shape.

In FIG. 6, the sleeve portion 60 shown is hollow. Therefore, the viscoelastic layer 6 is tubular, with inner and outer surfaces having, for example, a cylindrical cross section. The outer surface of the layer 6 is covered by an outer thermoformable layer 16a, which is tubular in shape, matching the shape of the outer surface of the layer 6. An inner tubular shaped layer 16b is inserted into the layer 6, the layer 16b being shaped to contact the entire inner surface of the layer 6. The inner layer 16b may or may not be thermoformable, depending on the intended applications.

To improve the bond between layer 6 and layer 16b, a bonding profile can be formed at the interface between these two layers. In the example shown in FIG. 6, this bonding profile comprises axial grooves formed in layer 16b and distributed over the cylindrical surface of layer 16b at the interface with layer 6, the grooves cooperate with matching ribs 26 formed in layer 16b. In the example shown in FIG. 6, the ribs 26 have a dovetail cross section. Thanks to its tubular shape, the handle portion 60 can be inserted on a handle, for example a racket handle, or a grip for example a hand tool handle. Because it is thermoformable, the handle portion 60 can be shaped to conform to the shape of the part of a user's hand that is in contact with the handle.

In another embodiment, the grooves are formed in layer 6 and the ribs 26 are formed in layer 16b.

In the embodiments of FIGS. 5 and 6, the handle or grip may be covered with a coating that may be suitable for contact with the hand, such as a viscoelastic material. Alternatively, in the embodiment of FIG. 6, the layer 16a may be omitted, such that the outer surface of the viscoelastic layer 6 is in direct contact with the hand.

FIG. 7 represents an insole 70 comprising a viscoelastic layer 7 in the same viscoelastic material as layer 1, and a thermoformable layer 17 in the same viscoelastic material as layer 11, the two layers being mechanically or chemically bonded to each other according to one and/or other of the various embodiments previously described. In the example of FIG. 7, the assembly mode of layers 7 and 17 corresponds to that described with reference to FIGS. 3A, 3B, with orifices 27 distributed in layer 17 (on the upper side of the insole shown in FIG. 7), each of the orifices 27 having an undercut profile in an axial plane (with respect to the orifice). The layer 17 also comprises an opening 37 encompassing a heel support zone, so that in this zone, where the pressure exerted by the foot may be maximum, the insole has a reduced hardness corresponding solely to the hardness of the viscoelastic layer 7, which is less hard than layer 17.

According to other embodiments, layers 7 and 17 are manufactured separately, and bonded together by a chemical and/or mechanical bond. Depending on the application, either layer 7 or layer 17 may be arranged to contact the sole of the foot.

According to another embodiment, layer 17 extends from the heel to the toes.

During a thermoforming operation of the insole 70 at a thermoforming temperature, the insole is pressed against the user's foot and held in that position until the temperature of the insole again reaches the temperature range of use.

The presence of the viscoelastic layer 1-7 in the device advantageously offers shock absorption and load distribution functions. For this purpose, the viscoelastic layer may have a Shore A hardness between 1 and 30, e.g., between 4 and 20, and a tensile strength between 1.5 and 5 MPa in the temperature ranges of use and thermoforming. In the application to an insole, the viscoelastic layer 7 has a Shore A hardness of 15 to 20, for example 16.

According to various embodiments, the viscoelastic layer 1-7 may be low-hardness SEBS (Styrene Ethylene Butylene Styrene), having a glass transition temperature of about 120° C., or silicone or silicone gel PDMS (PolyDimethylSiloxane), having a glass transition temperature of about 220° C. The viscoelastic layer 1-7 may also be a PU (Polyurethane) foam, or EVA (Ethylene-vinyl acetate) or PE (polyethylene).

According to various embodiments, the thermoformable layer 11-16a, 16b, 17 may be any of the following materials:

PCL (polycaprolactone) with a glass transition temperature of about 50° C.,

PLA (polylactide polyester) with a glass transition temperature of about 60° C.,

PETG (polyethylene terephthalate glycol) with a glass transition temperature of about 80° C.,

EVA with a glass transition temperature of about 85° C.,

PU or PE with a glass transition temperature below 100° C.,

or a thermoformable resin with a glass transition temperature below 100° C.

According to various embodiments, the layers 11-16a, 16b, 17 may have a thickness between 0.5 and 3 mm, and/or a stiffness (or Young's modulus) between 1 and 2 GPa.

According to various embodiments, the manufacturing of the device (pad 10, 20, 30, 40, handle 50, 60, insole 70) may include the following steps. The thermoformable layer 11-17 is manufactured by molding (by injection, casting, extrusion, . . . ) or additive manufacturing (3D printing). The resulting layer 11-17 is placed in a mold in the desired shape of the viscoelastic layer 1-7, where the viscoelastic layer is molded (by casting, injection, . . . ) to form the viscoelastic layer 1-7 by filling the mold with viscoelastic material in liquid form. In the case of the handle 50, the thermoformable layer 15 forms the mold for forming the viscoelastic layer 5. In the case of the handle 60, the layers 16a, 16b previously held in their final configuration, form the mold used to cast the viscoelastic layer 6.

According to another embodiment, the viscoelastic layer 1-7 and the thermoformable layer 11-15, 17, or the thermoformable layers 16a, 16b, are manufactured separately by molding (by casting, injection, extrusion, . . . ) or additive manufacturing, and then assembled by gluing or by means of mechanical connections such as complementary undercut shapes by exploiting the capacity of the viscoelastic layer to deform elastically (FIG. 4).

It will be apparent to the person skilled in the art that the present invention is susceptible to various alternatives and applications. In particular, the invention is not limited to an object to be applied to an area of a human or animal body, but can be used for any application requiring a thermoformable, shape-memory viscoelastic material having the properties indicated above.

Furthermore, several of the bonding modes of the thermoplastic and viscoelastic layers may be combined. Thus, the thermoformable layer may be bonded to the viscoelastic layer by both a chemical and a mechanical bonding mode. The holes or studs made in the thermoformable layer are not necessarily all of the same shape and size. In addition, the thermoformable layer may have both holes and studs, each of which cooperates with a complementary shape made in the viscoelastic layer.

1. A method of manufacturing a thermoformable shape-memory device, the method comprising the steps of:
forming a first layer of a thermoformable material that is inelastically deformable in a range of thermoforming temperatures;
forming a second layer of a viscoelastic material that is elastically deformable in a temperature range including the thermoforming temperature range and a use temperature range lower than the thermoforming temperature range, wherein the thermoformable material is elastically deformable and stiffer than the viscoelastic material in the use temperature range; and
joining the first layer to the second layer over a contact surface between the first layer and the second layer, by chemical bonding or mechanical bonds distributed over the contact surface, the device having a use shape defined by the first layer in the use temperature range, and having an original shape defined by the second layer providing a shape-memory function of the device in the thermoforming temperature range.

2. The method according to claim 1, wherein:
the first layer and the second layer are manufactured separately by molding or 3D printing and then assembled together, or
the first layer is manufactured by molding or 3D printing and then placed in a mold for manufacturing the second layer, the second layer being formed by molding using the mold including the first layer, or
the first layer is manufactured by molding or 3D printing, and forms a mold for the manufacture by molding of the second layer.

3. The method according to claim 1, comprising the steps of:
heating the device to a temperature within the thermoforming temperature range so that the device returns to the original shape defined by the second layer by transferring the original shape of the second layer to the first layer through the contact surface; and
bringing the device to a temperature within the use temperature range in which the device is elastically deformable.

4. The method according to claim 1, comprising the steps of:
heating the device to a first temperature within the thermoforming temperature range, and applying a deformation to the device at the first temperature to conform the device to a shape distinct from the original shape; and
bringing the device to a second temperature within the use temperature range while maintaining the deformation, the device at the second temperature being elastically deformable with respect to the shape distinct from the original shape.

5. A device comprising:
a first layer of a thermoformable material that is inelastically deformable in a thermoforming temperature range;
a second layer of a viscoelastic material that is elastically deformable in a temperature range including a use temperature range of the device and the thermoforming temperature range; and
wherein:
the use temperature range is lower than the thermoforming temperature range,
the first layer is bonded to the second layer by a chemical bond or mechanical bonds distributed over a contact surface between the first layer and the second layer,
the thermoformable material is elastically deformable and more rigid than the viscoelastic material in the use temperature range,
the thermoformable material is less rigid than the viscoelastic material in the thermoforming temperature range,
the first layer defines a form of use of the device in the use temperature range, and
the second layer defines an original shape of the device and achieves a shape-memory function of the device in the thermoforming temperature range.

6. The device according to claim 1, wherein the first layer is bonded to the second layer by one or a combination of the following:
a chemical bond made by a fusion of the materials forming the first and second layers, on either side of the contact surface between the first and second layers;
a layer of glue or a double-sided adhesive film, capable of chemically bonding to the first and second layers;
a mechanical connection based on a joining profile distributed over the contact surface; and
a seam.

7. The device according to claim 5, wherein the first layer is embedded in the second layer, and/or
the first layer comprises studs penetrating matching shaped holes in the second layer, and/or
the second layer comprises studs penetrating matching shaped holes in the first layer.

8. The device according to claim 5, wherein the first layer:
is PCL, PETG, EVA, PE, PU or PLA, or a thermoformable resin with a glass transition temperature below 100° C., and/or
has a stiffness between 1 and 2 GPa.

9. The device according to claim 5, wherein the second layer has at least one of the following features:
is SEBS, or silicone, or silicone gel, or PU, EVA or PE foam,
has a Shore A hardness between 1 and 30.

10. The device according to claim 5, wherein the second layer has the shape of an insole configured to cover the heel and the sole of a foot, and the first layer extends from the heel to the base of the metatarsal heads.

11. The device according to claim 10, wherein the second layer extends to the tip of the toes.

12. The device according to claim 5, wherein the first and second layers form a handle or a grip, intended to be held by a hand.

13. The device according to claim 12, wherein:
the second layer has a cylindrical shape, and the first layer has a tubular shape covering the second layer, or
the second layer has a tubular shape, and the first layer comprises a tubular-shaped inner portion covering an inner surface of the second layer, and a tubular-shaped outer portion covering an outer surface of the second layer, or
the second layer has a tubular shape, and the first layer comprises a tubular-shaped inner portion covering an inner surface of the second layer, the second layer being intended to be in contact with the hand.
